(19) United States
(12) Patent Application Publication
(10) Pub. No.: US 2025/0219256 A1
(43) Pub. Date: Jul. 3, 2025

(54) BATTERY STRUCTURE AND BATTERY MODULE

(71) Applicant: XING POWER INC., Victoria (SC)

(72) Inventors: Yu-Chung Lin, Taipei City (TW); Shang-Chih Dai, Taipei City (TW); Yu-Shun Chi, Taipei City (TW)

(73) Assignee: XING POWER INC., Victoria (SC)

(21) Appl. No.: 18/399,723

(22) Filed: Dec. 29, 2023

(51) Int. Cl. H01M 50/503; H01M 50/213; H01M 50/289; H01M 50/505

(52) U.S. Cl. CPC H01M 50/503; H01M 50/213; H01M 50/289; H01M 50/505

(57) ABSTRACT

A battery structure includes two battery modules and a conductive elastic member. The two battery modules are stacked with each other. Each of the two battery modules includes a housing, a plurality of battery cells, a first holder, a second holder, a first conductive plate and a second conductive plate. The battery cells are disposed in the housing. The first holder accommodates an end of each of the battery cells. The second holder accommodates another end of each of the battery cells. The first conductive plate is disposed on the first holder and electrically connected to the battery cells. The second conductive plate is disposed on the second holder and electrically connected to the battery cells. The conductive elastic member is disposed between and in contact with the first conductive plate and the second conductive plate of the two battery modules.

### BACKGROUND OF THE INVENTION

### 1. Field of the Invention

The invention relates to a battery structure and a battery module and, more particularly, to a battery structure and a battery module equipped with a conductive elastic member for achieving electrical connection between two battery modules.

### 2. Description of the Prior Art

Cell-to-pack (CTP) battery design is a manufacturing process used to create lithium-ion battery packs by directly integrating individual battery cells into the pack without using modular-based configuration. A battery pack may comprise a plurality of CTP battery modules assembled with each other to provide required voltage and capacity. However, the CTP battery modules need to be assembled by additional components to achieve electrical connection, such that the assembly process is complicated and waste time, and the cost increases due to additional components.

### SUMMARY OF THE INVENTION

The invention provides a battery structure and a battery module equipped with a conductive elastic member for achieving electrical connection between two battery modules, so as to solve the aforesaid problems.

According to an embodiment of the invention, a battery structure comprises two battery modules and a conductive elastic member. The two battery modules are stacked with each other. Each of the two battery modules comprises a housing, a plurality of battery cells, a first holder, a second holder, a first conductive plate and a second conductive plate. The plurality of battery cells are disposed in the housing. The first holder accommodates an end of each of the plurality of battery cells. The second holder accommodates another end of each of the plurality of battery cells. The first conductive plate is disposed on the first holder and electrically connected to the plurality of battery cells. The second conductive plate is disposed on the second holder and electrically connected to the plurality of battery cells. The conductive elastic member is disposed between and in contact with the first conductive plate and the second conductive plate of the two battery modules.

According to another embodiment of the invention, a battery module comprises a housing, a plurality of battery cells, a first holder, a second holder, a first conductive plate, a second conductive plate and a conductive elastic member. The plurality of battery cells are disposed in the housing. The first holder accommodates an end of each of the plurality of battery cells. The second holder accommodates another end of each of the plurality of battery cells. The first conductive plate is disposed on the first holder and electrically connected to the plurality of battery cells. The first conductive plate has two first restraining portions. The second conductive plate is disposed on the second holder and electrically connected to the plurality of battery cells. The conductive elastic member is restrained on the first conductive plate by the two first restraining portions.

As mentioned in the above, the invention disposes the conductive elastic member between the two battery modules to achieve electrical connection. Accordingly, the two battery modules do not need to be assembled by additional components, such that the assembly process can be simplified to save time and the cost can be reduced. Furthermore, when the two battery modules are stacked with each other, the conductive elastic member will be compressed to deform elastically, such that the conductive elastic member will be in contact with the first conductive plate and the second conductive plate of the two battery modules tightly, so as to absorb assembly tolerance and ensure electrical connection between the two battery modules.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view illustrating a battery structure according to an embodiment of the invention.

FIG. 2 is an exploded view illustrating the battery structure shown in FIG. 1.

FIG. 3 is an exploded view illustrating the battery structure shown in FIG. 1 from another viewing angle.

FIG. 4 is a sectional view illustrating the battery structure shown in FIG. 1.

FIG. 5 is an exploded view illustrating the inside of a battery module shown in FIG. 2.

FIG. 6 is an enlarged view illustrating parts of the battery module shown in FIG. 2.

FIG. 7 is an enlarged view illustrating a first pad and a second pad shown in FIG. 5.

FIG. 8 is a perspective view illustrating a battery module according to another embodiment of the invention.

FIG. 9 is an enlarged view illustrating parts of the battery module shown in FIG. 8.

### DETAILED DESCRIPTION

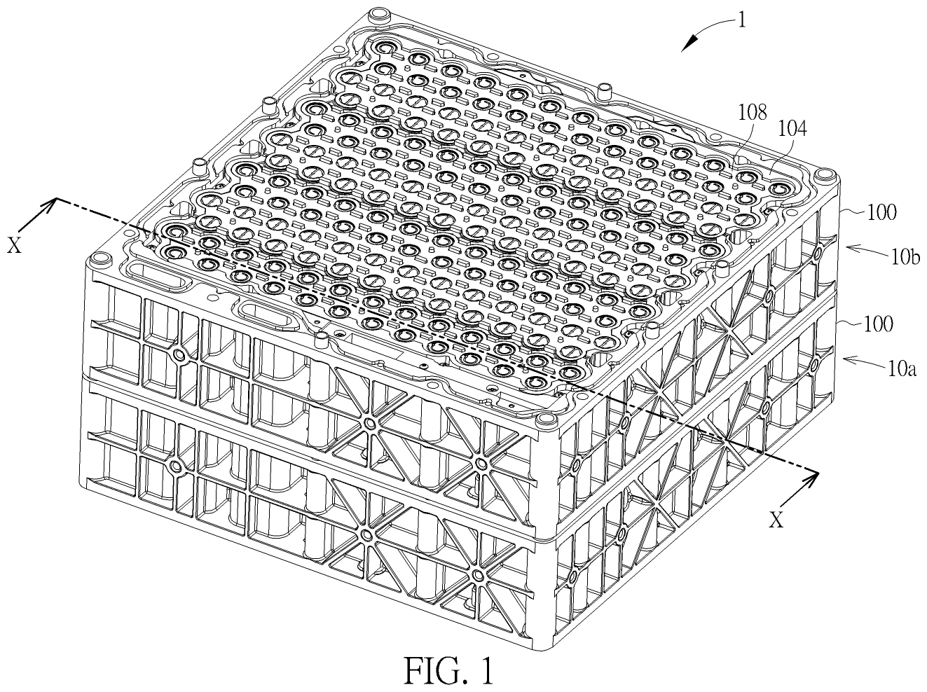

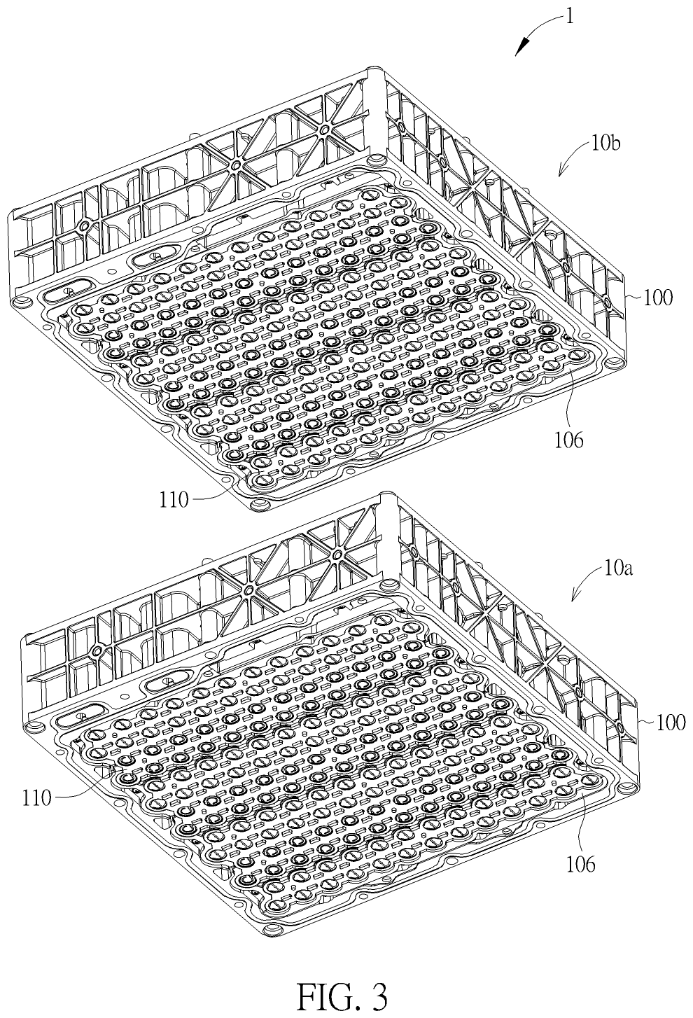

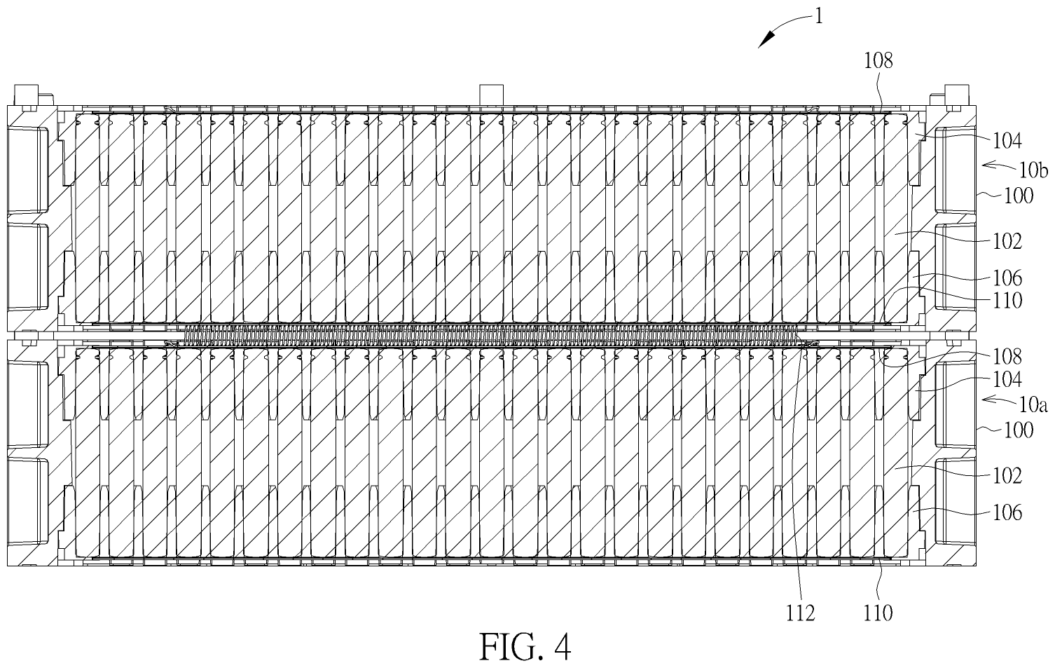

As shown in FIGS. 1 to 4, the battery structure 1 of the invention comprises two battery modules 10a, 10b, wherein the two battery modules 10a, 10b are stacked with each other. Furthermore, the battery structure 1 further comprises a conductive elastic member 112 disposed between and in contact with a first conductive plate 108 and a second conductive plate 110 of the two battery modules 10a, 10b, so as to achieve electrical connection between the two battery modules 10a, 10b. It should be noted that the number of battery modules may be determined according to practical applications, so the invention is not limited to the embodiment shown in the figures.

Each of the two battery modules 10a, 10b comprises a housing 100, a plurality of battery cells 102, a first holder 104, a second holder 106, a first conductive plate 108 and a second conductive plate 110. The battery cells 102 are disposed in the housing 100. The first holder 104 accommodates an end of each of the battery cells 102, and the second holder 106 accommodates another end of each of the battery cells 102. In this embodiment, the first holder 104 may have a plurality of accommodating holes 1040 for accommodating the battery cells 102, and the second holder 106 may also have a plurality of accommodating holes 1060 for accommodating the battery cells 102.

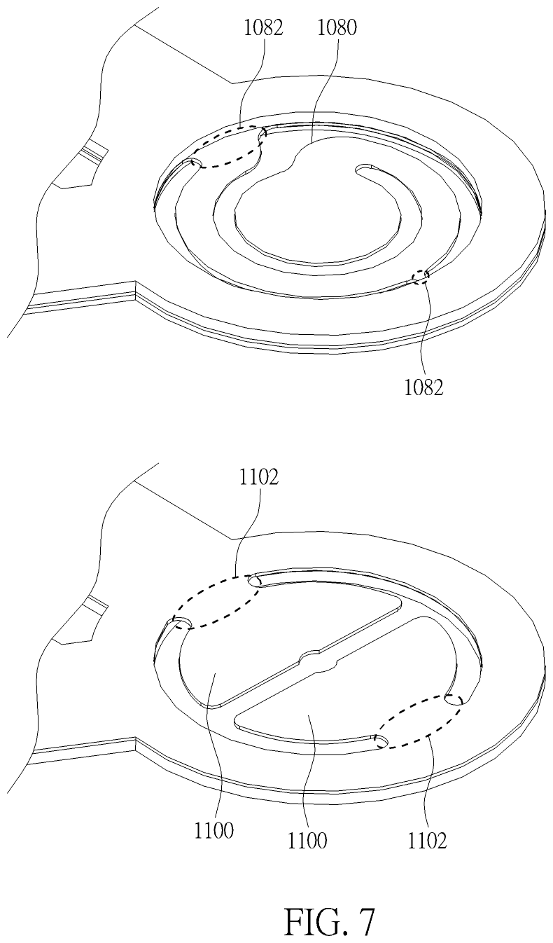

The first conductive plate 108 is disposed on the first holder 104 and electrically connected to the battery cells 102. Similarly, the second conductive plate 110 is disposed on the second holder 106 and electrically connected to the battery cells 102. For further explanation, the first conductive plate 108 may have a plurality of first pads 1080 in contact with the battery cells 102, and the second conductive plate 110 may have a plurality of second pads 1100 in contact with the battery cells 102. The first pads 1080 and the second pads 1100 may be soldered with the positive and negative terminals of the battery cells 102. Furthermore, a shape of each of the first pads 1080 may be different from a shape of each of the second pads 1100, as shown in FIG. 7.

In this embodiment, each of the first pads 1080 is connected to the first conductive plate 108 by at least one first connecting portion 1082, each of the second pads 1100 is connected to the second conductive plate 110 by at least one second connecting portion 1102, and a total cross-sectional area of the at least one first connecting portion 1082 is smaller than a total cross-sectional area of the at least one second connecting portion 1102. For example, each of the first pads 1080 may consist of two semicircular structures connected to the first conductive plate 108 by two first connecting portions 1082, and each of the second pads 1100 may be a spiral structure connected to the second conductive plate 110 by two second connecting portions 1102. In this case, the total cross-sectional area of the two first connecting portions 1082 is smaller than the total cross-sectional area of the two second connecting portions 1102. Accordingly, when the current exceeds the design value, the two first connecting portions 1082 will be burned out first, thereby causing the corresponding battery cell 102 to form an open circuit. Therefore, the invention can provide over-current protection function for each of the battery cells 102.

It should be noted that the number of first conductive plates 108 and second conductive plates 110 may be determined according to practical applications. Furthermore, the first conductive plate 108 may also have a plurality of second pads 1100 and the second conductive plate 110 may also have a plurality of first pads 1080. Therefore, the invention may adjust the number of battery modules, first conductive plates 108 and second conductive plates 110, and adjust the series and parallel connection of battery cells by the arrangement of first pads 1080 and second pads 1100, so as to adjust the voltage and capacity of the battery structure.

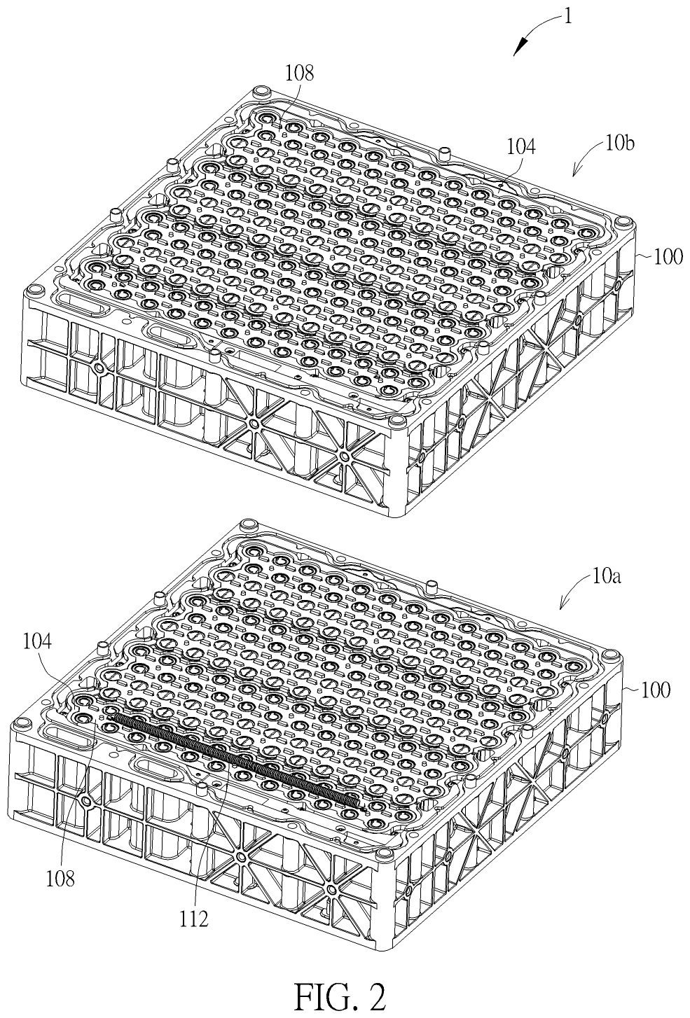

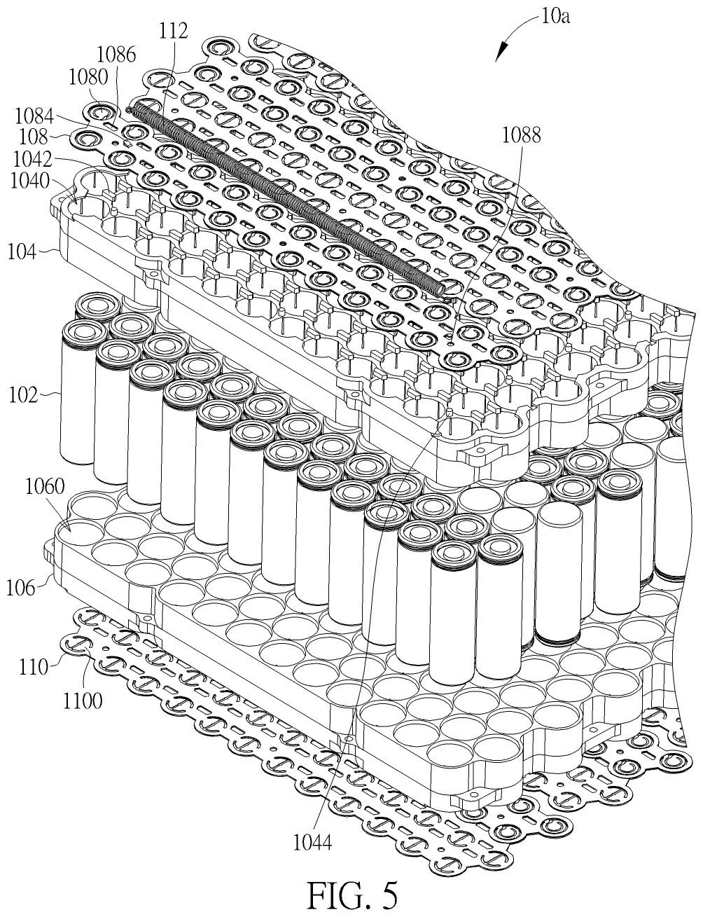

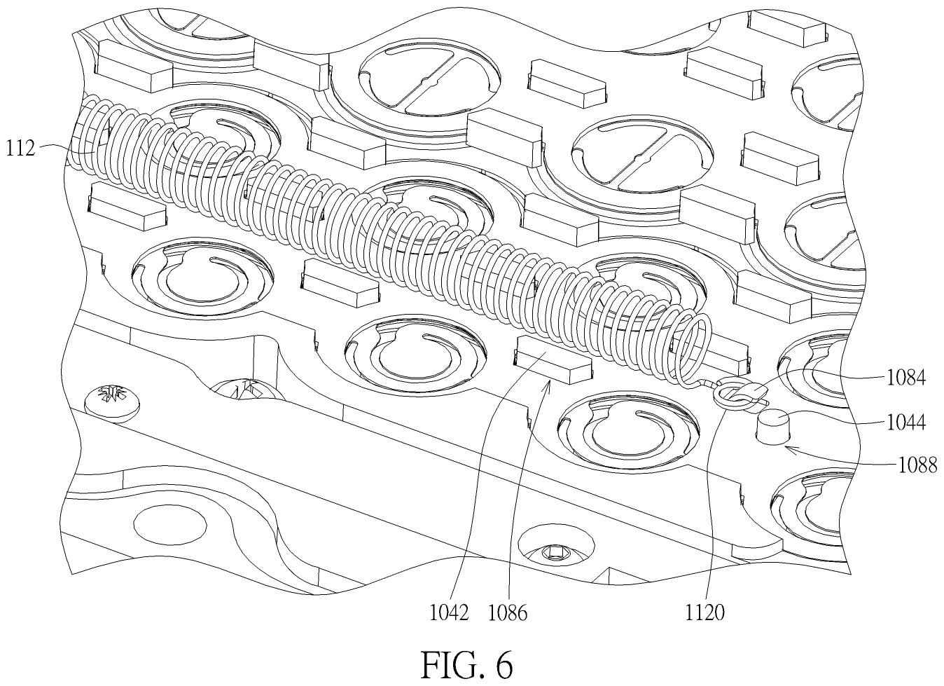

As shown in FIGS. 2, 5 and 6, the battery module 10a further comprises the conductive elastic member 112 disposed on the first conductive plate 108. In this embodiment, the first conductive plate 108 of the battery module 10a may have two first restraining portions 1084, and the conductive elastic member 112 may be restrained on the first conductive plate 108 by the two first restraining portions 1084. For example, the conductive elastic member 112 may be a coil spring with two ring-shaped ends 1120, and the two ring-shaped ends 1120 are hooked by the two first restraining portions 1084, so as to restrain the conductive elastic member 112 on the first conductive plate 108. The two first restraining portions 1084 may be bent from the first conductive plate 108, but the invention is not so limited.

Furthermore, the first holder 104 may have a plurality of second restraining portions 1042 and the first conductive plate 108 may further have a plurality of through holes 1086. When the first conductive plate 108 is disposed on the first holder 104, the second restraining portions 1042 pass through the through holes 1086. Then, after the conductive elastic member 112 is disposed on the first conductive plate 108, the second restraining portions 1042 are located at opposite sides of the conductive elastic member 112 in a radial direction of the conductive elastic member 112. In this embodiment, the second restraining portions 1042 may be interlacedly located at the opposite sides of the conductive elastic member 112. Thus, when the battery module 10b is stacked on the battery module 10a and compresses the conductive elastic member 112, the conductive elastic member 112 will deform elastically and the second restraining portions 1042 can restrain the position of the conductive elastic member 112. In addition, the compression of the conductive elastic member 112 may be adjusted by the height of the second restraining portions 1042. For example, the height of the second restraining portions 1042 may be smaller than half the height of the conductive elastic member 112, but the invention is not so limited. Still further, the second restraining portions 1042 may extend to the accommodating holes 1040 to restrain the battery cells 102 in the accommodating holes 1040.

Moreover, the first holder 104 may have a plurality of positioning portions 1044 and the first conductive plate 108 may further have a plurality of positioning holes 1088. When the first conductive plate 108 is disposed on the first holder 104, the positioning portions 1044 pass through the positioning holes 1088 to position the first conductive plate 108 on the first holder 104. In this embodiment, the positioning portions 1044 may be made of plastic material, such that the positioning portions 1044 may be melted to tightly fix the first conductive plate 108 on the first holder 104.

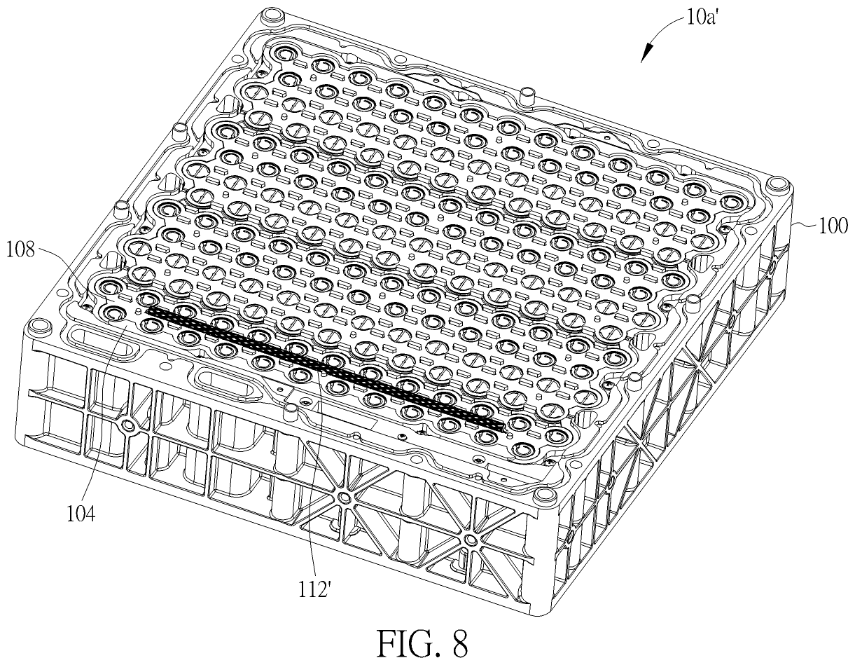

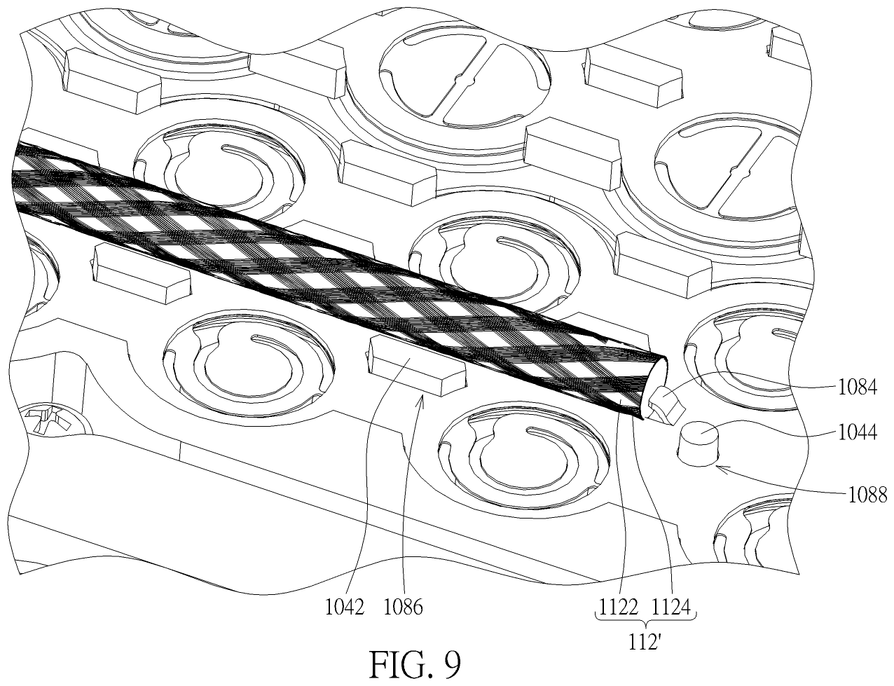

Referring to FIGS. 8 and 9, the main difference between the battery module 10a′ and the aforesaid battery module 10a is that the conductive elastic member 112′ of the battery module 10a′ comprises an elastic structure 1122 and a conductive material 1124, wherein the elastic structure 1122 is covered with the conductive material 1124, as shown in FIGS. 8 and 9. The elastic structure 1122 may be made of rubber, sponge or other elastic materials, and the conductive material 1124 may be made of conductive metal. In this embodiment, the two first restraining portions 1084 of the first conductive plate 108 may abut against two ends of the elastic structure 1122, so as to restrain the conductive elastic member 112′ on the first conductive plate 108.

The battery module 10a shown in FIGS. 1 to 4 may be replaced by the battery module 10a′ shown in FIG. 8. When the battery module 10b is stacked on the battery module 10a′ and compresses the conductive elastic member 112′, the conductive elastic member 112′ will deform elastically and the second restraining portions 1042 can restrain the position of the conductive elastic member 112′. Thus, the conductive elastic member 112′ is disposed between and in contact with the first conductive plate 108 and the second conductive plate 110 of the two battery modules 10a′, 10b, so as to achieve electrical connection between the two battery modules 10a′, 10b.

As mentioned in the above, the invention disposes the conductive elastic member between the two battery modules to achieve electrical connection. Accordingly, the two battery modules do not need to be assembled by additional components, such that the assembly process can be simplified to save time and the cost can be reduced. Furthermore, when the two battery modules are stacked with each other, the conductive elastic member will be compressed to deform elastically, such that the conductive elastic member will be in contact with the first conductive plate and the second conductive plate of the two battery modules tightly, so as to absorb assembly tolerance and ensure electrical connection between the two battery modules.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A battery structure comprising:
two battery modules stacked with each other, each of the two battery modules comprising:
a housing;
a plurality of battery cells disposed in the housing;
a first holder accommodating an end of each of the plurality of battery cells;
a second holder accommodating another end of each of the plurality of battery cells;
a first conductive plate disposed on the first holder and electrically connected to the plurality of battery cells; and
a second conductive plate disposed on the second holder and electrically connected to the plurality of battery cells; and
a conductive elastic member disposed between and in contact with the first conductive plate and the second conductive plate of the two battery modules.

2. The battery structure of claim 1, wherein the first conductive plate of one of the two battery modules has two first restraining portions, and the conductive elastic member is restrained on the first conductive plate by the two first restraining portions.

3. The battery structure of claim 2, wherein the conductive elastic member is a coil spring with two ring-shaped ends, and the two ring-shaped ends are hooked by the two first restraining portions.

4. The battery structure of claim 2, wherein the conductive elastic member comprises an elastic structure and a conductive material, the elastic structure is covered with the conductive material, and the two first restraining portions abut against two ends of the elastic structure.

5. The battery structure of claim 1, wherein the first holder has a plurality of second restraining portions, the first conductive plate further has a plurality of through holes, and the plurality of second restraining portions pass through the plurality of through holes and are located at opposite sides of the conductive elastic member in a radial direction of the conductive elastic member.

6. The battery structure of claim 5, wherein the plurality of second restraining portions are interlacedly located at the opposite sides of the conductive elastic member.

7. The battery structure of claim 5, wherein the first holder further has a plurality of accommodating holes for accommodating the plurality of battery cells, and the plurality of second restraining portions extend to the plurality of accommodating holes to restrain the plurality of battery cells in the plurality of accommodating holes.

8. The battery structure of claim 1, wherein the first holder has a plurality of positioning portions, the first conductive plate further has a plurality of positioning holes, and the plurality of positioning portions pass through the plurality of positioning holes to position the first conductive plate on the first holder.

9. The battery structure of claim 1, wherein the first conductive plate has a plurality of first pads in contact with the plurality of battery cells, the second conductive plate has a plurality of second pads in contact with the plurality of battery cells, and a shape of each of the plurality of first pads is different from a shape of each of the plurality of second pads.

10. The battery structure of claim 9, wherein each of the plurality of first pads is connected to the first conductive plate by at least one first connecting portion, each of the plurality of second pads is connected to the second conductive plate by at least one second connecting portion, and a total cross-sectional area of the at least one first connecting portion is smaller than a total cross-sectional area of the at least one second connecting portion.

11. A battery module comprising:
a housing;
a plurality of battery cells disposed in the housing;
a first holder accommodating an end of each of the plurality of battery cells;
a second holder accommodating another end of each of the plurality of battery cells;
a first conductive plate disposed on the first holder and electrically connected to the plurality of battery cells, the first conductive plate having two first restraining portions;
a second conductive plate disposed on the second holder and electrically connected to the plurality of battery cells; and
a conductive elastic member restrained on the first conductive plate by the two first restraining portions.

12. The battery module of claim 11, wherein the conductive elastic member is a coil spring with two ring-shaped ends, and the two ring-shaped ends are hooked by the two first restraining portions.

13. The battery module of claim 11, wherein the conductive elastic member comprises an elastic structure and a conductive material, the elastic structure is covered with the conductive material, and the two first restraining portions abut against two ends of the elastic structure.

14. The battery module of claim 11, wherein the first holder has a plurality of second restraining portions, the first conductive plate further has a plurality of through holes, and the plurality of second restraining portions pass through the plurality of through holes and are located at opposite sides of the conductive elastic member in a radial direction of the conductive elastic member.

15. The battery module of claim 14, wherein the plurality of second restraining portions are interlacedly located at the opposite sides of the conductive elastic member.

16. The battery module of claim 14, wherein the first holder further has a plurality of accommodating holes for accommodating the plurality of battery cells, and the plurality of second restraining portions extend to the plurality of accommodating holes to restrain the plurality of battery cells in the plurality of accommodating holes.

17. The battery module of claim 11, wherein the first holder has a plurality of positioning portions, the first conductive plate further has a plurality of positioning holes, and the plurality of positioning portions pass through the plurality of positioning holes to position the first conductive plate on the first holder.

18. The battery module of claim 11, wherein the first conductive plate has a plurality of first pads in contact with the plurality of battery cells, the second conductive plate has a plurality of second pads in contact with the plurality of battery cells, and a shape of each of the plurality of first pads is different from a shape of each of the plurality of second pads.

19. The battery module of claim 18, wherein each of the plurality of first pads is connected to the first conductive plate by at least one first connecting portion, each of the plurality of second pads is connected to the second conductive plate by at least one second connecting portion, and a total cross-sectional area of the at least one first connecting portion is smaller than a total cross-sectional area of the at least one second connecting portion.
